(19) United States
(12) Patent Application Publication
(10) Pub. No.: US 2009/0034559 A1
(43) Pub. Date: Feb. 5, 2009

(54) VIDEO APPARATUS HAVING PVR FUNCTION AND CONTROL METHOD THEREOF

(75) Inventor: Choon-sik Jung, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/021,471

(22) Filed: Jan. 29, 2008

(30) Foreign Application Priority Data
Jul. 31, 2007 (KR) 10-2007-0076968

(51) Int. Cl. H04J 3/06

(52) U.S. Cl. 370/512

(57) ABSTRACT

A video apparatus having a personal video recorder (PVR) function and a control method thereof are provided. The video apparatus includes a counter which assigns a timestamp to a transport stream packet, a synchronization unit which extracts time information from the transport stream packet, compares the extracted time information with system time information of the video apparatus, and outputs synchronization control information, and a controller which stores an information table created using the timestamp and synchronization control information.

### CROSS-REFERENCE TO RELATED APPLICATIONS

This application claims priority from Korean Patent Application No. 10-2007-0076968, filed on Jul. 31, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a personal video recorder (PVR) function, and more particularly, to a PVR function to store programs received from an external source.

2. Description of the Related Art

Video apparatuses having a PVR function store broadcast signals received from external sources and play back the broadcast signals, similarly to video cassette recorders (VCRs). However, such video apparatuses record information on a hard disk and play back files in the same manner as computers, and thus differ from VCRs.

Such video apparatuses receive Moving Picture Experts Group (MPEG)-2 transport streams and demultiplex program packets related to desired programs to divide a received transport stream into partial transport streams. Next, a timestamp, which is information required for synchronization, is attached to each partial transport stream, and the partial transport streams containing the timestamp are stored in recording media, such as hard disk drives (HDDs), compact discs (CDs), digital video discs (DVDs) or other media. Each partial transport stream stored in recording apparatuses is output, synchronized and played back according to its timestamp.

FIG. 1 is a block diagram showing a related art video apparatus having a PVR function.

In FIG. 1, a received digital broadcast signal is demultiplexed by a transport stream (TS) demultiplexer (DEMUX) 105 into partial transport streams of a program to be stored. A clock counter for storage 115 outputs a timestamp for the partial transport streams based on a regular frequency output from a crystal oscillator 110. A storage packetizer 120 converts the timestamp of the partial transport streams output from the clock counter for storage 115 and the partial transport streams into disc packets, which is a storage format that can be selected according to the type of storage media, and transfers the converted disc packets to a recording apparatus 125 through a data bus 122 so that the disc packets may be stored in the recording apparatus 125.

If the stored program is played back, the disc packets stored in the recording apparatus 125 may be transferred to a playback depacketizer 135 within the TS DEMUX 105 through the data bus 122. The playback depacketizer 135 compares the timestamp of the storage format attached to every transport stream with an output of a clock counter for playback 130. As a result, if it is determined that the timestamp and output are input at the same time, the input partial transport streams may be output as audio/video (A/V) elementary streams by the TS DEMUX 105, and each A/V elementary stream may be decoded by an A/V decoder 140 to be played back.

The related art video apparatus having the PVR function exactly extracts the timestamp during storage and playback of a program, and combines or separates the extracted timestamp and the partial transport streams. In this process of the conventional video apparatus, there is a need to read output values of the clock counter for storage from each transport stream packet, to convert the read output values into storage formats during storage of the program, and to compare output values of the clock counter for playback for each transport stream packet during playback of the program.

Therefore, the timestamp may be attached to or detached from each transport stream when the transport stream is stored or played back in the PVR, which is complex process. Additionally, the memory capacity becomes larger in order to store the data storage format on hardware, and MPEG jitter may arise due to delays when extracting and attaching the timestamp.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a video apparatus having a PVR function and a control method thereof in which a program table including information, such as clock, synchronization and timestamp information related to playback of a program, is stored together with program data during storage of the program, so that MPEG jitter may be minimized and the complexity of the program and the additional resources required may be reduced, so that it is easier to control the video apparatus.

According to an aspect of the present invention, there is provided a video apparatus comprising a counter which assigns a timestamp to a transport stream packet; a synchronization unit which extracts time information from the transport stream packet, compares the extracted time information with system time information of the video apparatus, and outputs synchronization control information; and a controller which creates an information table using the timestamp and synchronization control information, and stores the created information table.

The synchronization unit may control output of the transport stream packet through a synchronization control signal generated based on the synchronization control information.

The video apparatus may further comprise a crystal oscillator which changes frequency according to the synchronization control signal. The synchronization unit may transfer the synchronization control signal generated based on the synchronization control information to the crystal oscillator, and may change the frequency, so that output of the transport stream packet may be controlled.

The video apparatus may further comprise a buffer. If each disc packet has been completely stored in a storage medium, the controller may store the timestamp and synchronization control information in the buffer.

If the program has been completely stored, the controller may compute an average bit rate of a program using the timestamp stored in the buffer.

The controller may create the information table using the timestamp and synchronization control information, which are stored for each disc packet in the buffer, and using the average bit rate of the program.

According to another aspect of the present invention, there is provided a control method of a video apparatus, the method comprising assigning a timestamp to a transport stream packet; extracting time information from the transport stream packet, comparing the extracted time information with system time information of the video apparatus, and outputting synchronization control information; and creating an information table using the timestamp and synchronization control information, and storing the created information table.

The method may further comprise storing the synchronization control information and the timestamp assigned to the transport stream packet if each disc packet has been completely stored in a storage medium.

The method may further comprise computing an average bit rate of a program using the stored timestamp if the program has been completely stored.

The information table may be created using the timestamp and synchronization control information, which are stored for each disc packet, and using the average bit rate of the program.

According to another aspect of the present invention, there is provided a video apparatus comprising a storage unit which stores an information table, which comprises a timestamp and synchronization control information, which are stored for each disc packet, and an average bit rate of a program; a synchronization unit which generates a synchronization control signal based on the synchronization control information and outputs the generated synchronization control signal; a crystal oscillator which changes frequency according to the synchronization control signal; and a controller which outputs the disc packets according to the timestamp based on the average bit rate of the program, and controls output of the disc packet using the synchronization control information according to the changed frequency output from the crystal oscillator.

The controller may check whether the synchronization control information changes for each disc packet. If the synchronization control information changes, the controller may control output of the disc packets using the changed synchronization control information.

According to another aspect of the present invention, there is provided a control method of a video apparatus, the method comprising checking an information table, which comprises a timestamp and synchronization control information, which are stored for each disc packet, and an average bit rate of a program; generating a synchronization control signal based on the synchronization control information and outputting the generated synchronization control signal; changing frequency according to the synchronization control signal; and outputting the disc packets according to the timestamp based on the average bit rate of the program, and controlling output of the disc packets using the synchronization control information according to the changed frequency.

The method may further comprise checking whether the synchronization control information changes for each disc packet; and controlling output of the disc packets using the changed synchronization control information if the synchronization control information changes.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram showing a related art video apparatus having a PVR function;

FIG. 2 is a block diagram showing a video apparatus having a PVR function according to an exemplary embodiment of the present invention;

FIG. 3 is a detailed block diagram showing a synchronization unit according to an exemplary embodiment of the present invention;

FIG. 4 is a diagram showing a disc packet according to an exemplary embodiment of the present invention;

FIG. 5 is a flowchart explaining a program storage method according to an exemplary embodiment of the present invention; and

FIG. 6 is a flowchart explaining a data playback method according to an exemplary embodiment of the present invention.

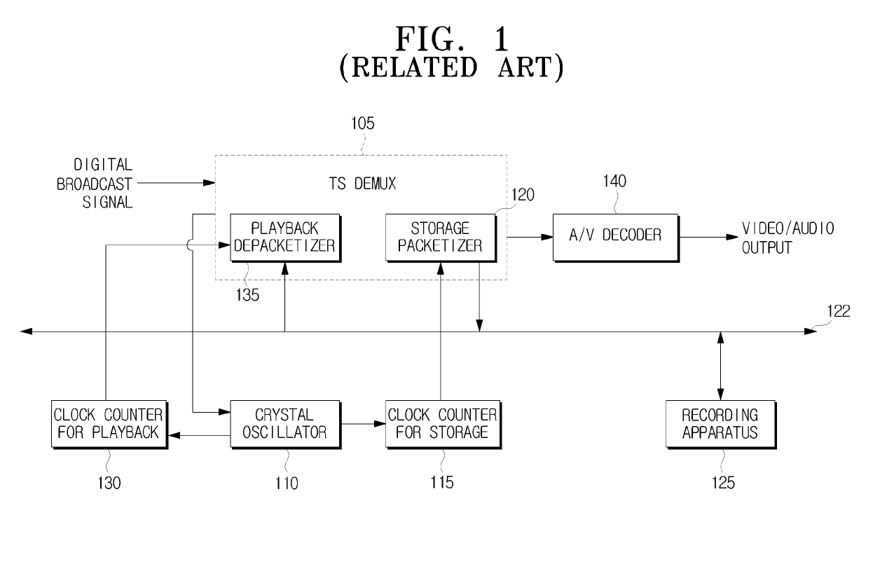

### DETAILED DESCRIPTION OF EXEMPLARY EMBODIMENTS OF THE INVENTION

Exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they may obscure the invention with unnecessary detail.

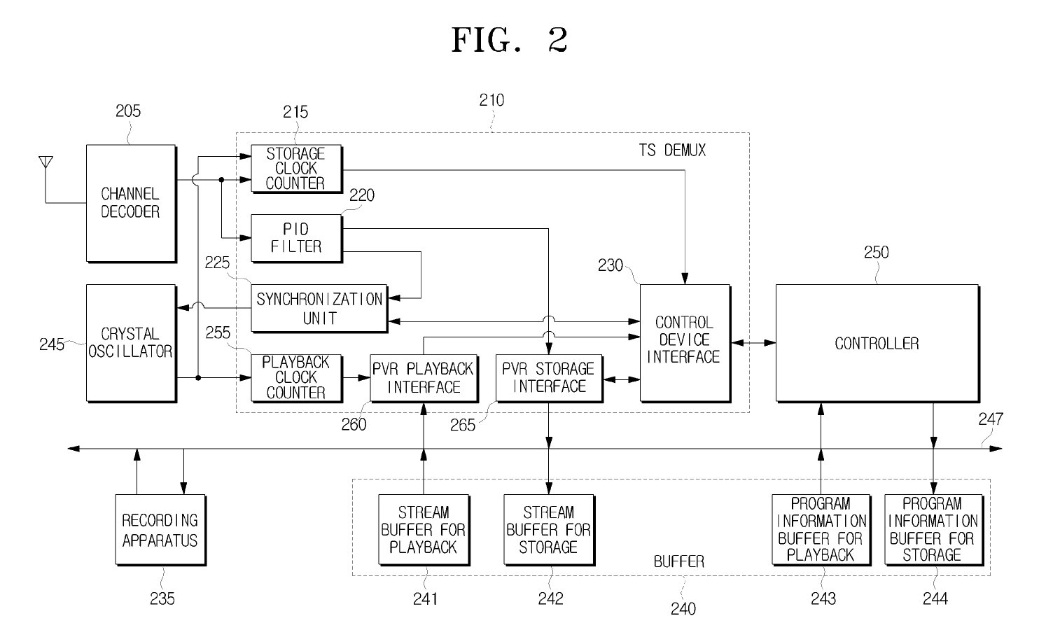

FIG. 2 is a block diagram showing a video apparatus having a PVR function according to an exemplary embodiment of the present invention.

The video apparatus of FIG. 2 comprises a channel decoder 205, a transport stream (TS) demultiplexer (DEMUX) 210, a recording apparatus 235, a buffer 240, a crystal oscillator 245, a data bus 247 and a controller 250.

The TS DEMUX 210 comprises a storage clock counter 215, a proportional-integral-derivative (PID) filter 220, a synchronization unit 225, a control device interface 230, a playback clock counter 255, a PVR playback interface 260 and a PVR storage interface 265. The buffer 240 comprises a stream buffer for playback 241, a stream buffer for storage 242, a program information buffer for playback 243 and a program information buffer for storage 244.

The channel decoder 205 decodes a broadcast signal received via a tuner, and outputs a transport stream packet of a digital broadcast to the TS DEMUX 210.

The TS DEMUX 210 demultiplexes the output transport stream packet, extracts partial transport streams including audio/video (A/V) signals, and generates and outputs a timestamp and synchronization control information, which are associated with the partial transport streams.

In more detail, the storage clock counter 215 of the TS DEMUX 210 assigns the timestamp to every transport stream packet according to clocks output from the crystal oscillator 245, and outputs the transport stream packets containing the timestamp to the controller 250 through the control device interface 230. The PID filter 220 filters a selected program from the output transport stream packets, and outputs partial transport streams of the selected program to the synchronization unit 225 and PVR storage interface 265.

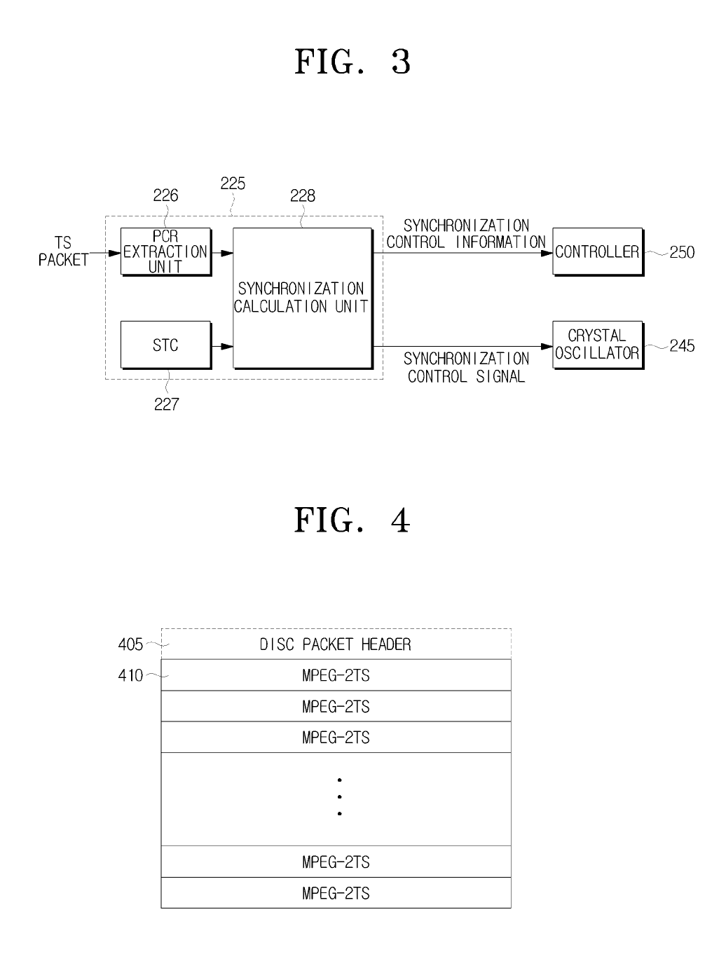

The synchronization unit 225 extracts time information from the transport stream packets, and compares the extracted time information with system time information of the video apparatus to output the synchronization control information and to output a synchronization control signal required for performing synchronization. The synchronization unit 225 is shown in detail in FIG. 3. FIG. 3 is a detailed block diagram showing the synchronization unit 225 according to an exemplary embodiment of the present invention.

The synchronization unit 225 comprises a program clock reference (PCR) extraction unit 226, a system time clock (STC) 227 and a synchronization calculation unit 228.

The PCR extraction unit 226 extracts clock information regarding the partial transport streams transferred from the PID filter 220. Specifically, the PCR extraction unit 226 extracts PCR information from the received transport stream packets. The STC 227 outputs system clock information corresponding to a reference clock required to operate the video apparatus.

The synchronization calculation unit 228 receives the PCR information regarding the partial transport streams which is extracted by the PCR extraction unit 226 and the system clock information output from the STC 227. Using a difference between the PCR information and system clock information, the synchronization calculation unit 228 generates synchronization information required to synchronize the clock of the transmission terminal and the clock of the video apparatus, and generates a synchronization control signal in order to perform synchronization. Specifically, the synchronization calculation unit 228 compares the PCR information with the system clock information when a transport stream packet is generated, and generates synchronization information using the difference between the PCR information and STC information, based on a 27 Mhz MPEG-2 clock. Additionally, the synchronization calculation unit 228 controls the crystal oscillator 245 to generate a synchronization control signal in order to synchronize the system clock of the video apparatus.

The synchronization calculation unit 228 transfers the synchronization information to the controller 250 through the control device interface 230, and also transfers the synchronization control signal to the crystal oscillator 245.

Referring back to FIG. 2, the playback clock counter 255 adjusts the output rate of the partial transport streams according to the clock output from the crystal oscillator 245.

The PVR playback interface 260 is an interface used to play back a program. The PVR playback interface 260 reads the disc packet in which the partial transport streams are stored from the recording apparatus 235, stores the read disc packet in the stream buffer for playback 241 and plays back the partial transport streams, according to an adjustment signal output from the playback clock counter 255.

The PVR storage interface 265 is an interface through which a user may store a program. The PVR storage interface 265 temporarily stores the partial transport streams until the capacity of all the disc packets, that is, the storage format of the recording apparatus 235, is exceeded, and records the partial transport streams in the recording apparatus 235 after the capacity of all the disc packets is exceeded.

The recording apparatus 235 may be an apparatus capable of storing data using a hard disk drive (HDD) or a storage medium such as a compact disc (CD) or a digital video disc (DVD) capable of storing the partial transport streams and information table in the disc packet.

The buffer 240 temporarily stores the timestamp and synchronization control information required to create partial transport streams and an information table.

The crystal oscillator 245 outputs clocks having the regular period used as a reference of the operation of the video apparatus, and changes the output clocks according to the synchronization control signal.

The data bus 247 is a standardized passage enabling data transmission and reception between the TS DEMUX 210, controller 250, buffer 240 and recording apparatus 235, so that data may be transferred in two directions.

The controller 250 creates an information table based on the timestamp and synchronization control information for each partial transport stream, which are transferred from the TS DEMUX 210.

Specifically, if a predetermined syncword, whose value is 0 X 47, indicating the start of the transport stream packet is detected, the controller 250 may store the timestamp and synchronization control information in the program information buffer for storage 244 according to the clock output from the crystal oscillator 245. The controller 250 may then temporarily store the disc packets containing the partial transport streams in the stream buffer for storage 242, and if the capacity of all the disc packets is exceeded, the controller 250 may store the disc packets in the recording apparatus 235. Additionally, the controller 250 may store the timestamp and synchronization control information in the program information buffer for storage 244 at the time when the capacity of all the disc packets is exceeded.

Until the program is completely stored, the controller 250 may repeat the above process of storing the partial transport streams in the disc packet, storing the synchronization control information and timestamp in the program information buffer for storage 244 in the first portion and last portion of the disc packet.

If the program has been completely stored, the controller 250 may compute an average bit rate of the program using the timestamp stored in the program information buffer for storage 244.

Specifically, if the disc packet comprises n partial transport streams, the controller 250 may compute the difference between the timestamp time when the capacity of all the disc packets is exceeded and the timestamp time when the disc packet is formed, and may thus measure time required to complete a single data packet.

Accordingly, the controller 250 may compute the number of total periods required to complete a single disc packet based on a period of clocks output at a rate of approximately 27 Mhz from the crystal oscillator 245 according to the MPEG-2 standard, and may measure the time required to complete a single disc packet. The measured time is divided by n partial transport streams of approximately 188 bytes contained in the disc packet, so that the average bit rate of the partial transport streams can be obtained. Additionally, the average bit rate of the total program may be computed using the average bit rate of the partial transport streams computed according to the regular period.

The controller 250 creates a program information table based on the timestamp and synchronization control information stored in every disc packet and the average bit rate of the program, and stores the created program information table in a separate area of the recording apparatus 235.

FIG. 4 is a diagram showing a disc packet according to an exemplary embodiment of the present invention.

FIG. 4 shows a disc packet 410 used as a storage format to store partial transport streams of a program in the recording apparatus 235. A plurality of MPEG-2 transport streams are arranged in the disc packet 410, and a user may store predetermined data in a disc packet header 405 of the disc packet 410.

If the program is played back according to the created information table, the controller 250 may analyze the timestamp, synchronization control information and average bit rate of the program contained in the program information table.

The controller 250 may then output the disc packets according to the timestamp based on the average bit rate of the program, and may control output of the disc packet according to the changed frequency output based on the synchronization control information.

Specifically, the controller 250 may transfer a control signal to the synchronization unit 225, and may cause the clocks to be output from the crystal oscillator 245 according to the average bit rate of the program.

Accordingly, the PVR playback interface 260 reads the disc packet in which the partial transport streams are stored from the recording apparatus 235, stores the read disc packet in the stream buffer for playback 241 and outputs the disc packet, according to the adjustment signal output from the playback clock counter 255.

The controller 250 checks the synchronization control information for each partial transport stream stored in the disc packet. As a result of checking, only when the synchronization control information is changed, the controller 250 may transfer the changed synchronization control information to the synchronization unit 225 so that the clock output from the crystal oscillator 245 may be changed.

Therefore, the same characteristics of the clocks may be represented according to the synchronization control information. Digital broadcasting generally complies with the MPEG-2 standard, in which a variation width of 27 Mhz is set to 0.075 Hz or less, so synchronization may differ according to the broadcast station. However, when storing and playing back a single program, the variation width is very narrow. Accordingly, it is possible to set the variation width based on the synchronization control information at one time during initial playback.

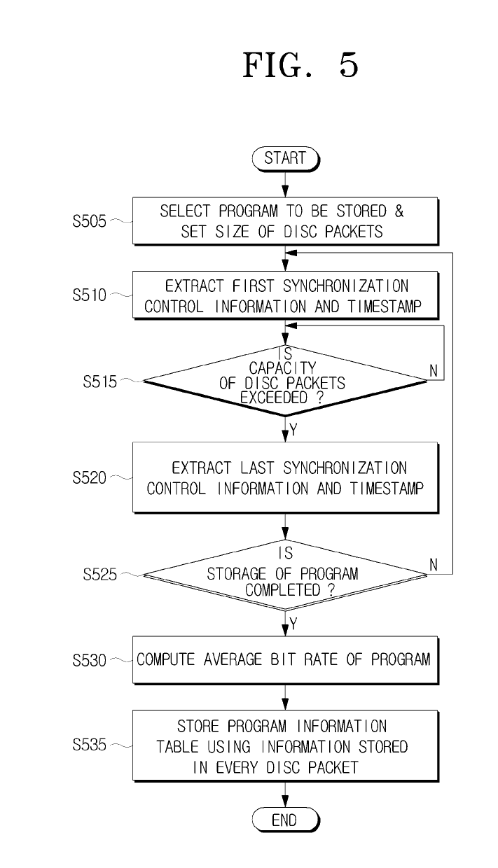

Hereinafter, a method for storing a program in the video apparatus having the PVR function shown in FIG. 2 will be described in detail with reference to FIG. 5. FIG. 5 is a flowchart explaining a program storage method according to an exemplary embodiment of the present invention.

The controller 250 selects a program to be stored and sets the size of the disc packet (S505). Specifically, the controller 250 causes the selected program to be filtered by the PID filter 220 in the transport stream packet, and then sets the size of the disc packet of the recording apparatus 235.

If a predetermined syncword, whose value is 0 X 47, is detected indicating the start of the transport stream packet, the controller 250 may store first synchronization control information and a timestamp in the program information buffer for storage 244 (S510).

The controller 250 checks whether the capacity of all the disc packets is exceeded (S515). In more detail, the controller 250 temporarily stores the disc packet containing the partial transport streams in the stream buffer for storage 242, and then checks whether the capacity of all the disc packets is exceeded. If the capacity of all the disc packets is exceeded, the controller 250 may store the partial transport streams in the recording apparatus 235.

If it is determined that the capacity of all the disc packets is exceeded (S515-Y), the controller 250 may store last synchronization control information and a timestamp in the program information buffer for storage 244 at the time when the capacity of all the disc packets is exceeded (S520).

The controller 250 then checks whether the program has been completely stored (S525).

If it is determined that the program has not been completely stored (S525-N), the controller 250 may repeat operations S510, S515 and S520.

If it is determined that the program has been completely stored (S525-Y), the controller 250 may compute the average bit rate of the program using the timestamp stored in the program information buffer for storage 244 (S530).

The controller 250 then creates a program information table based on the timestamp and synchronization control information stored in every disc packet and the average bit rate of the program, and stores the created program information table in a separate area of the recording apparatus 235 (S535).

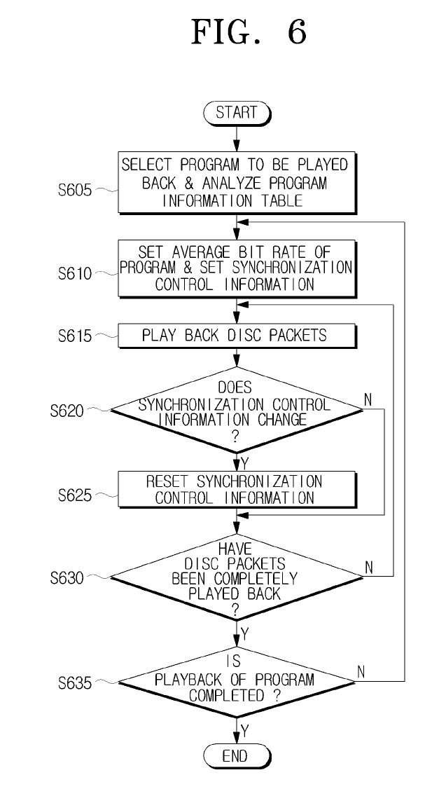

Hereinafter, a method for playing back a program in the video apparatus having the PVR function shown in FIG. 2 will be described in detail with reference to FIG. 6. FIG. 6 is a flowchart explaining a program playback method according to an exemplary embodiment of the present invention.

The controller 250 selects a program to be played back and analyzes the program information table (S605). Specifically, the controller 250 analyzes the timestamp, synchronization control information and average bit rate of the program contained in the program information table.

The controller 250 then sets the average bit rate of the program and the synchronization control information (S610). In other words, the controller 250 transfers the disc packet containing the partial transport streams to the PVR playback interface 260 according to the average bit rate of the program.

Next, the controller 250 plays back the disc packet (S615). In more detail, the controller 250 outputs the disc packet according to the timestamp contained in the program information table.

The controller 250 then checks whether the synchronization control information changes for each partial transport stream stored in the disc packet (S620).

If it is determined that the synchronization control information changes (S620-Y), the controller 250 may reset the synchronization control information (S625).

Alternatively, if it is determined that the synchronization control information remains unchanged (S620-N), the controller 250 may maintain the synchronization control information without change.

The controller 250 then checks whether the disc packet has been completely played back (S630).

If it is determined that the disc packet has not been completely played back (S630-N), the controller 250 may repeat operations S615, S620 and S625.

If it is determined that the disc packet has been completely played back (S630-Y), the controller 250 may check whether playback of the program is completed (S635).

If it is determined that the program is currently being played back (S635-N), the controller 250 may repeat the operations of playing back the disc packet.

As described above, according to an exemplary embodiment of the present invention, a program table including information related to playback of a program is stored together with program data during storage of the program, and thus it is possible to minimize MPEG jitter and reduce the complexity of the program and the additional resources required so that it is easier to control the video apparatus.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A video apparatus comprising:
a counter which assigns a timestamp to a transport stream packet;
a synchronization unit which extracts time information from the transport stream packet, compares the extracted time information with system time information of the video apparatus, and outputs synchronization control information; and
a controller which creates an information table using the timestamp and synchronization control information, and stores the created information table.

2. The video apparatus as claimed in claim 1, wherein the synchronization unit controls output of the transport stream packet through a synchronization control signal generated based on the synchronization control information.

3. The video apparatus as claimed in claim 2, further comprising:
a crystal oscillator which changes an output frequency according to the synchronization control signal,
wherein the synchronization unit transfers the synchronization control signal to the crystal oscillator, and changes the output frequency of the crystal oscillator, so that output of the transport stream packet is controlled.

4. The video apparatus as claimed in claim 1, further comprising:
a buffer,
wherein the controller stores the timestamp and the synchronization control information in the buffer if each of at least one disc packet has been completely stored in a storage medium.

5. The video apparatus as claimed in claim 4, wherein the controller computes an average bit rate of a program using the timestamp stored in the buffer if the program has been completely stored.

6. The video apparatus as claimed in claim 5, wherein the controller creates the information table using the timestamp and the synchronization control information, which are stored for each of at least one disc packet in the buffer, and using the average bit rate of the program.

7. A control method of a video apparatus, the method comprising:
assigning a timestamp to a transport stream packet;
extracting time information from the transport stream packet, comparing the extracted time information with system time information of the video apparatus, and outputting synchronization control information; and
creating an information table using the timestamp and synchronization control information, and storing the created information table.

8. The method as claimed in claim 7, further comprising:
storing the synchronization control information and the timestamp if each of at least one disc packet has been completely stored in a storage medium.

9. The method as claimed in claim 7, further comprising:
computing an average bit rate of a program using the stored timestamp if the program has been completely stored.

10. The method as claimed in claim 9, wherein the information table is created using the timestamp and the synchronization control information, which are stored for each of at least one disc packet, and using the average bit rate of the program.

11. A video apparatus comprising:
a storage unit which stores an information table and an average bit rate of a program, the information table comprising a timestamp and synchronization control information which are stored for each of at least one disc packet;
a synchronization unit which generates a synchronization control signal based on the synchronization control information and outputs the generated synchronization control signal;
a crystal oscillator which changes an output frequency according to the synchronization control signal; and
a controller which outputs the at least one disc packet according to the timestamp based on the average bit rate of the program, and controls output of the at least one disc packet using the synchronization control information according to the changed output frequency output from the crystal oscillator.

12. The video apparatus as claimed in claim 11, wherein the controller checks whether the synchronization control information changes for each of the at least one disc packet, and controls output of the at least one disc packet using the changed synchronization control information if the synchronization control information changes.

13. A control method of a video apparatus, the method comprising:
checking an information table, the information table comprising a timestamp and synchronization control information, which are stored for each of at least one disc packet, and an average bit rate of a program;
generating a synchronization control signal based on the synchronization control information;
outputting the generated synchronization control signal;
changing an output frequency according to the synchronization control signal;
outputting the at least one disc packet according to the timestamp based on the average bit rate of the program,
wherein the outputting of the at least one disc packet is controlled using the synchronization control information according to the changed output frequency.

14. The method as claimed in claim 13, further comprising:
checking whether the synchronization control information changes for each of the at least one disc packet; and
controlling output of the at least one disc packet using the changed synchronization control information if the synchronization control information changes.
